(19) United States
(12) Patent Application Publication
(10) Pub. No.: US 2015/0266326 A1
(43) Pub. Date: Sep. 24, 2015

(54) PRINTING APPARATUS AND PRINTING METHOD

(71) Applicant: CANON KABUSHIKI KAISHA, Tokyo (JP)

(72) Inventor: Kengo Nieda, Kawasaki-shi (JP)

(21) Appl. No.: 14/645,929

(22) Filed: Mar. 12, 2015

(30) Foreign Application Priority Data
Mar. 24, 2014 (JP) 2014-060482

(51) Int. Cl. B41J 29/393; B41J 2/01

(52) U.S. Cl. CPC B41J 29/393; B41J 2/01

(57) ABSTRACT

There is provided a method in which in a line-type printing apparatus, a print position deviation due to an error in conveying velocity of a sheet and a print position deviation specific in a printing head are respectively detected from a predetermined test pattern, and a normal correction is made to each of them. Therefore the test pattern printed while conveying the sheet is measured, and an actual conveying velocity of the sheet and a print position deviation specific in the printing head are respectively calculated based upon a print position deviation between the plurality of printing heads obtained from the measured test pattern.

### BACKGROUND OF THE INVENTION

1. Field of the Invention

The present invention relates to a printing apparatus that prints an image on a sheet to be conveyed, and a method for detecting a print position deviation in the printing apparatus.

2. Description of the Related Art

In a line-type printing apparatus, a sheet (printing medium) is conveyed in a constant velocity in a direction crossing an array direction of a plurality of printing elements relative to a line printing head in which the plurality of printing elements are arrayed until a range corresponding to the width of the sheet, thus forming an image on the sheet. Further, in a case of using a color printer, the above line printing heads the number of which is equal to that of ink colors are arranged in a conveying direction of the sheet, and dots in a plurality of colors are printed in accordance with image data.

On this occasion, the conveying velocity of the sheet becomes unstable in a case where conveying rollers, which come in contact with the sheet and rotate therewith to convey the sheet, have tolerances. Further, in some cases the conveying velocity of the sheet changes with kinds or sizes of the sheet itself. In a case where the conveying velocity of the sheet exceeds a desired velocity, even when the printing heads print dots in a constant frequency, a distance between the two continuous dots becomes the larger to enlarge the image itself in the conveying direction. In reverse, in a case where the conveying velocity of the sheet is below the desired velocity, the distance between the two continuous dots becomes the smaller to narrow the image itself in the conveying direction.

In addition, a print position between a plurality of printing heads becomes unstable due to tolerances of the respective line printing heads or mounting errors of the line printing heads. When such a print position deviation between the printing heads occurs, there are some cases where dots of different colors that are supposed to overlap are separated or dots that are supposed to be separated overlap, so that desired color reproduction cannot be obtained.

For the above reason, in the recent line-type printing apparatus in which a high-quality image is demanded, an issue of stabilizing a conveying velocity of a sheet and maintaining high accuracy in print position between a plurality of printing heads is becoming an important task.

For example, Japanese Patent Laid-Open No. 2012-35477 discloses a method for printing a test pattern in advance prepared, detecting this printed test pattern with a sensor, and thereby correcting a print position of an individual printing head. In addition, Japanese Patent Laid-Open No. 2012-35477 describes the structure that even in a case where a conveyance error of the sheet occurs at the pattern detection, the pattern detection or the correction of the conveyance error is normally performed.

Japanese Patent Laid-Open No. 2012-35477, however, simply describes the method in which even in a case where conveyance error of the sheet occurs at the time of performing the test pattern detection, the print position of the individual printing head is detected with high accuracy, but the conveyance error itself is not measured or the print position deviation occurring due to the conveyance error is not corrected.

According to the findings by the present inventors, in a case of more positively correcting the print position deviation due to the conveyance error with high accuracy, it is preferable to prepare a test pattern of which the conveyance error can be detected and detect the test pattern. However, when the conveyance error of the apparatus and the print position deviation of the individual printing head occur simultaneously, the printed test pattern also includes both the print position deviation due to the conveyance error and the print position deviation specific in the printing head. As a result, it is difficult to make a normal correction to each of the errors.

### SUMMARY OF THE INVENTION

The present invention is made for solving the foregoing problems. An object of the present invention is to provide a method for detecting each of a print position deviation due to an error in a conveying velocity of a sheet and a print position deviation specific in a printing head from a predetermined test pattern to make a normal correction to each of the print position deviations in a line-type printing apparatus.

In a first aspect of the present invention, there is provided an printing apparatus comprising: a plurality of line-type printing heads, a print control unit configured to control such that a test pattern constructed of a plurality of patches is printed on a conveyed sheet by using the plurality of printing heads; an obtaining unit configured to obtain a deviation amount of each of the plurality of patches based upon the result of detecting the test pattern; and a calculating unit configured to calculate a print position deviation due to a conveyance error of the sheet and a print position deviation specific in each of the plurality of printing heads, based upon the deviation amount of each of the plurality of patches.

In a second aspect of the present invention, there is provided a printing method comprising the steps of: printing a test pattern constructed of a plurality of patches on a conveyed sheet by using a plurality of line-type printing heads; obtaining a deviation amount of each of the plurality of patches based upon the result of detecting the test pattern; calculating a print position deviation due to a conveyance error of the sheet and a print position deviation specific in each of the plurality of printing heads, based upon the deviation amount of each of the plurality of patches; adjusting an ejection frequency of the plurality of printing heads based upon the calculated print position deviation due to the conveyance error of the sheet; and adjusting ejection timing of each of the plurality of printing heads based upon the print position deviation specific in each of the plurality of printing heads.

Further features of the present invention will become apparent from the following description of exemplary embodiments (with reference to the attached drawings).

### BRIEF DESCRIPTION OF THE DRAWINGS

FIG. 1 is a cross section showing a line printing apparatus usable in the present invention;

FIG. 2 is a cross section for explaining the configuration of a printing unit;

FIG. 3 is a plan view showing one printing head as viewed from an ejection opening face thereof;

FIG. 4 is a block diagram explaining the configuration of control for detection and correction of a print position deviation;

FIGS. 5A to 5F are diagrams each showing a printing state of a test pattern;

FIG. 6 is a concept diagram showing a calculation process of calculating a conveying velocity of a sheet and a print position deviation amount of an individual printing head;

FIG. 7 is a block diagram for explaining the configuration of detecting and correcting a cyclic conveying velocity fluctuation of a sheet;

FIGS. 8A and 8B are diagrams showing printing states of two test patterns having different phases;

FIG. 9 is a block diagram explaining the control configuration of detection and correction of the print position deviation; and

FIG. 10 is a diagram showing an example of test patterns for a user to make a visual determination.

### DESCRIPTION OF THE EMBODIMENTS

### First Embodiment

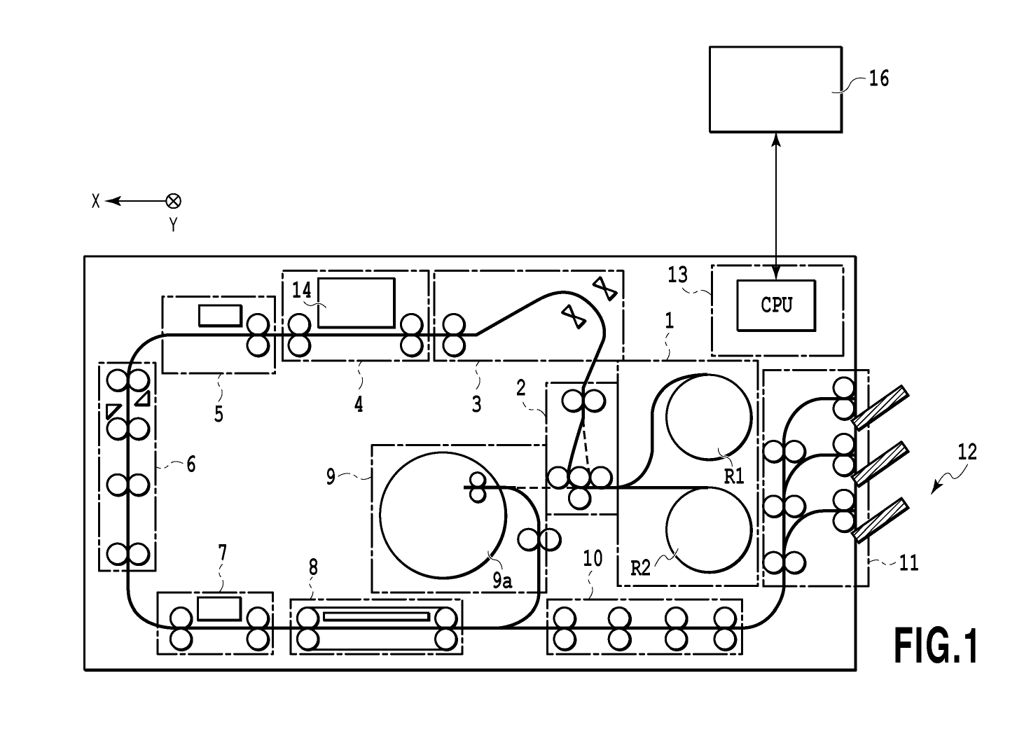

FIG. 1 is a cross section showing a line-type printing apparatus usable in the present invention. This line-type printing apparatus is a relatively large-sized color printer that is suitable for a printing field of printing a large amount of sheets, such as in a case of a printing laboratory.

A sheet supply unit 1 accommodates therein two rolls R1 and R2 and selectively pulls out sheets therewith, and the pulled sheet is supplied to a conveying path. It should be noted that the number of the rolls that can be accommodated in the sheet supply unit 1 is not limited to two, but one, three or more rolls may be accommodated therein.

A decal unit 2 is a unit for reducing a curl of the sheet supplied from the sheet supply unit 1 or a reverse unit 9 to be described later. In the decal unit 2, two pinch rollers are pressed to one drive roller to create a curl in a direction in reverse to the above curl to the sheet. When the sheet passes the decal unit 2, the curl of the sheet having occurred in the sheet supply unit 1 or the reverse unit 9 is reduced, and therefore the sheet is smoothly conveyed.

An oblique-pass correcting unit 3 is a unit for correcting an oblique movement (inclination to a forward direction) of the sheet having passed the decal unit 2. The sheet is directed to go straight ahead by pressing a sheet end portion thereof as a base side on a guide member.

A printing unit 4 ejects ink on the conveyed sheet from a printing head 14 to form an image thereon. The printing unit 4 prints image data, and besides, a cut mark showing a position of cutting the sheet, a test pattern for confirming a printing state of the printing head, and the like. The printing unit 4 is provided with a plurality of conveying rollers that convey the sheet, wherein the conveying rollers support the sheet so that the sheet in a region facing the printing head 14 is made flat and smooth.

The printing head 14 is constructed of line printing heads of an inkjet system in which a plurality of nozzles (printing elements) that eject ink are arrayed in a direction crossing a conveying direction of the sheet in a range of covering the maximum width of the sheet supposed to be used. These line printing heads the number of which corresponds to that of ink colors are arranged in parallel in the conveying direction. The ink of each color is supplied to the printing head 14 through each of ink tubes from ink tanks (not shown). The details of the printing unit 4 and the individual printing heads 14 will be described later.

An inspection unit 5 is a unit that is provided with a line sensor composed of an image sensor such as a CCD or a CMOS and optically reads an inspection pattern or an image that is printed on the sheet in the printing unit 4. The read information is transferred to a controlling unit 13, which determines a print position deviation amount of the printing head 14, a conveyance error of the sheet, and the like, based upon the read information.

A cutter unit 6 is provided with a sensor that detects a cut mark, and a cutter that cuts the sheet based upon a position or timing of the detected cut mark. The cut sheet, that is, the image sheet (page) is conveyed to the next process by a plurality of conveying rollers. On the other hand, a non-image sheet between the images is accommodated in a trash bin. However, in a case of double-sided printing, the cutter unit 6 only cuts a rear end portion of the final image in regard to a first face thereof, and the continuous sheet is conveyed to an information printing unit 7 without being cut.

The information printing unit 7 prints information such as serial numbers and dates in regard to a print image as characters or codes on a blank area of the image sheet. A drying unit 8 is a unit for drying the applied ink in a short time, and provides a hot air to the image sheet passing therein from a back face side of the image sheet in reverse to the printing face, thus drying the ink. It should be noted that the drying method is not limited to the method for providing the hot air, but may be a method for emitting electromagnetic wave (ultraviolet ray or infrared ray) on the sheet surface.

The path from the sheet supply unit 1 to the drying unit 8 as described above is called a first path. The first path is formed in a U-turn shape between the printing unit 4 and the drying unit 8, and the cutter unit 6 is positioned along the way of the U-turn shape. The first path is a path where the sheet passes in common in either double-sided printing or one-sided printing. The continuous sheet the first face printing of which is completed in the double-sided printing passes the first path, and thereafter is conveyed to a second path provided with the reverse unit 9. On the other hand, the cut sheet the second face printing of which is completed in the double-sided printing or the cut sheet at a point where the one-sided printing is completed passes the first path, and thereafter is conveyed to a third path provided with a discharge conveying unit 10.

The reverse unit 9 is a unit for temporarily reeling the continuous sheet on which the first face printing is completed at double-sided printing. The continuous sheet on which the first face printing is completed is gradually reeled by a drum 9a rotating in a counterclockwise direction. The drum 9a stops in a point of reeling the continuous sheet to the rear end portion, and thereafter rotates in a reverse direction, that is, in a clockwise direction. As a result, the continuous sheet is fed out to the decal unit 2. The decal unit 2 corrects the sheet in a direction of reducing the curl of the sheet that has occurred at the time of being reeled by the drum 9a.

In the path leading to the printing unit 4 from the decal unit 2, the continuous sheet is in a state of being reverse in the front-back relation and in the front-rear end portion relation. That is, the continuous sheet is conveyed such that the second face opposes the printing head 14 and the rear end portion at the first face printing becomes the front end portion. In this way, the path from a point where the sheet fed out from the drying unit 8 is reversed in the front-back relation to a point where the sheet is fed into the decal unit 2 is called a second path.

The discharge conveying unit 10 conveys the cut sheet, which is cut in the cutter unit 6 and is dried in the drying unit 8, to a sorter unit 11. The sorter unit 11 sorts the printed cut sheets in groups for each size group or the like, and discharges each group of the cut sheets to the corresponding discharge port. Each of the discharge ports is provided with a tray 12 for receiving the cut sheet, and the cut sheet is loaded on any of the trays 12. In this way, the path until the sheet fed out from the drying unit 8 is discharged to the tray 12 is called a third path. Although not shown in FIG. 1, a movable flapper is provided downstream of the drying unit 8 and in a branch position of the path for selectively guiding the sheet conveyed from the first path to either one of the second path or the third path.

The controlling unit 13 is a unit for managing control of the entire printing apparatus. An operation of the entire printing apparatus is controlled based upon a command from the controlling unit 13 or from a host device 16 connected to an external device.

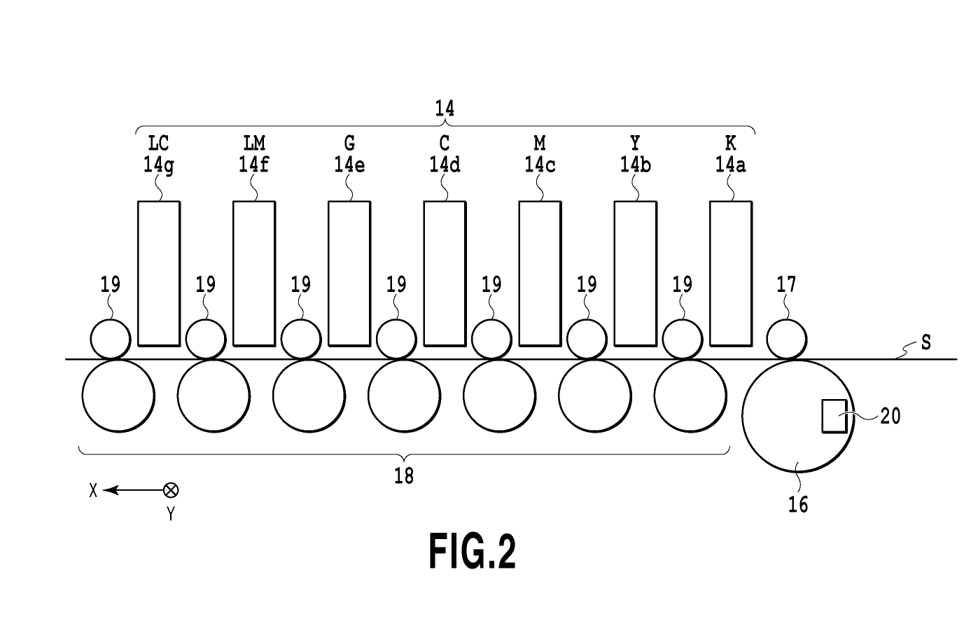

FIG. 2 is a cross section explaining the configuration of the printing unit 4. A sheet S fed into the printing unit 4 is conveyed in an X direction by a total of eight conveying roller pairs comprising a conveying roller pair composed of a main conveying roller 16 and a main pinch roller 17 that are positioned in the most upstream side, and conveying roller pairs each composed of a sub conveying roller 18 and a sub pinch roller 19. On this occasion, a pressure of the roller pair of the main conveying roller 16 and the main pinch roller 17 on the sheet S is sufficiently larger than pressures of other roller pairs, and the conveying of the sheet S is controlled substantially by the roller pair of the main conveying roller 16 and the main pinch roller 17. An encoder unit 20 attached to the main conveying roller 16 detects a rotational phase of the main conveying roller 16, and transmits the result to the controlling unit 13. The controlling unit 13 recognizes a conveying state of the sheet S based upon the information obtained from the encoder unit 20 to perform motor control for driving the main conveying roller 16 and the sub conveying rollers 18. It should be noted that the sheet S has a loop shape upstream of the main conveying roller 16 and downstream of the sub conveying roller 18 in the most downstream side, so that the state of the sheet conveying before or after the printing unit 4 does not affect the conveying of the sheet within the printing unit 4.

The inkjet printing heads 14 each of which is disposed between the conveying roller pairs are lined up in parallel, and eject ink in accordance with image data on the sheet S moving under the printing heads 14. The seven printing heads 14 are arrayed in the order of black (K), yellow (Y), magenta (M), cyan (C), gray (G), light magenta (LM), and light cyan (LC) from the upstream side.

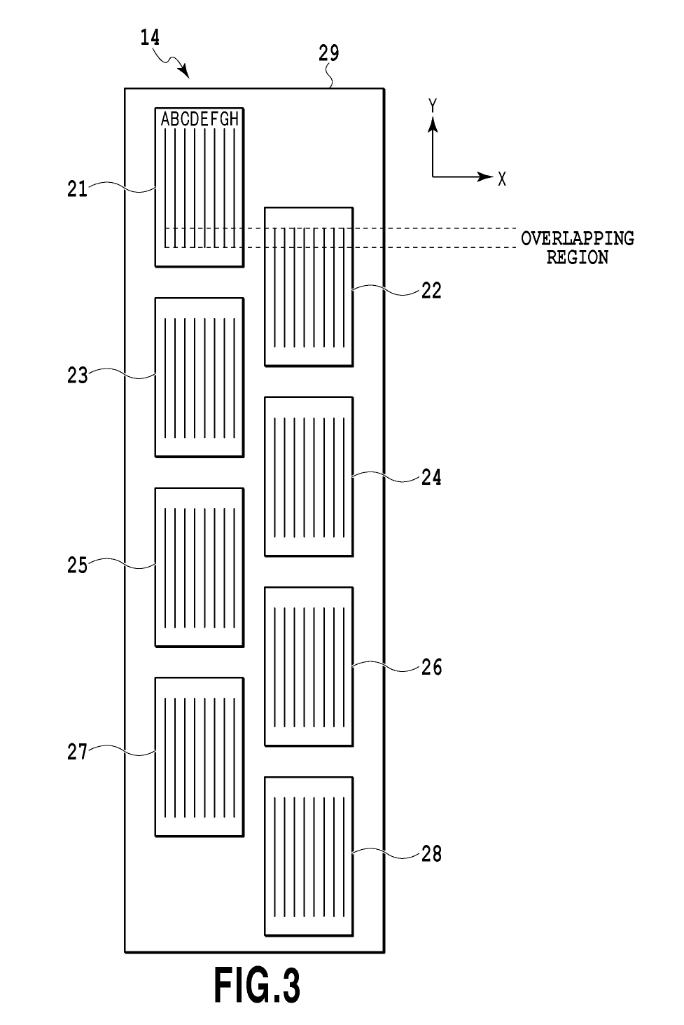

FIG. 3 is a plan view showing one printing head 14 as viewed from an ejection opening face thereof. A base substrate (support member) 29 of the printing head 14 is provided thereon with eight chips 21 to 28 formed of, for example, silicon to be arranged alternately in an X direction as shown in the figure. Each of the chips 21 to 28 is provided thereon with eight nozzle lines 30 lined up in the X direction, each line having a plurality of nozzles arrayed in a Y direction. The eight chips 21 to 28 are arranged to be continuous in the Y direction while having an overlapping region to each other as shown in the figure, therefore realizing the printing head 14 having a print width of eight inches in the Y direction. It should be noted that in regard to the inkjet method, the method for using the heater element is adopted, and in addition thereto, there maybe adopted various methods such as a method for using a piezo element, a method for using an electrostatic element or a method for using an MEMS element.

With this configuration, each of the nozzles ejects ink to the sheet conveyed in a constant velocity in the X direction in accordance with the printing data, thus an image having the width of eight inches at the maximum is printed on the sheet. At this time, on the area of one dot width that is continuous in the X direction, ejection operations are alternately performed in a non-overlapping region by eight nozzle lines and in an overlapping region by 16 nozzle lines.

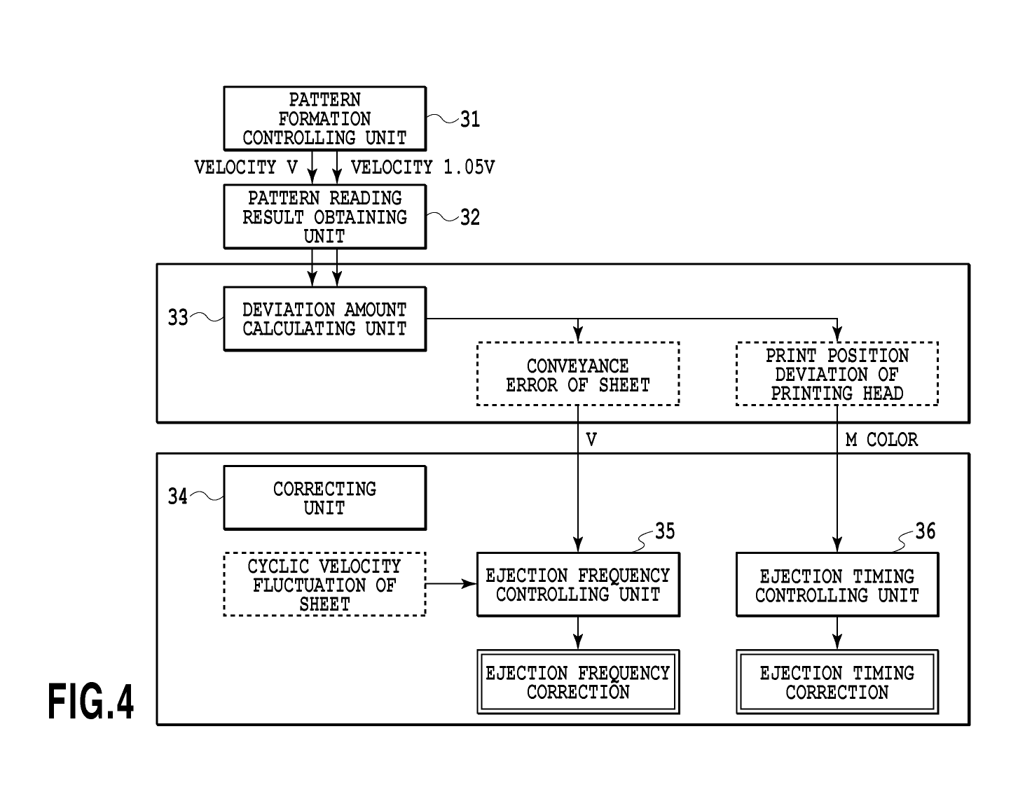

FIG. 4 is a block diagram explaining the configuration of control for detection and correction of a print position deviation that is executed by the controlling unit 13. This control configuration is substantially realized in such a manner that a CPU in the controlling unit 13 reads out programs stored in the memory or the like and executes the read program.

In the present embodiment, the print position deviation due to the conveyance error of the sheet and the print position deviation specific in the printing head are targets for correction. The print position deviation due to the conveyance error is corrected by controlling an ejection frequency of all the printing heads, and the print position deviation specific in each of the printing heads is corrected by adjusting ejection timing of each of the printing heads other than a reference printing head to the reference printing head.

For realizing this correction, the controlling unit 13 prints a predetermined test pattern on the sheet S, detects the printed test pattern, and obtains a print position deviation amount due to a conveyance error of the sheet and a print position deviation amount specific in each of the printing heads, based upon the obtained information. The ejection frequency of all the printing heads is corrected based upon the print position deviation amount due to the conveyance error, and the ejection timing of each of the printing heads is corrected based upon the print position deviation amount specific in each of the printing heads.

At this time, the printing of the test pattern is performed by a pattern formation controlling unit 31. The pattern formation controlling unit 31 prints an equal test pattern in each of a state of fixing the conveying velocity in a predetermined velocity V (first conveying velocity) and a state of fixing the conveying velocity in 1.05 times of the predetermined velocity V (second conveying velocity). A pattern reading result obtaining unit 32 uses the inspection unit 5 to detect the two patterns (first test pattern and second test pattern) printed by the pattern formation controlling unit 31 and transmit each of the results to a deviation amount calculating unit 33.

The deviation amount calculating unit 33 calculates the print position deviation amount due to the conveyance error and the print position deviation amount of each of the printing heads, based upon the two detection results according to a predetermined formula. The details of the calculation method will be described later. The print position deviation amount due to the conveyance error and the print position deviation amount of each of the printing heads calculated by the deviation amount calculating unit 33 are transmitted to a correcting unit 34.

The correcting unit 34 includes an ejection frequency controlling unit 35 that controls an ejection frequency of all the printing heads, and an ejection timing controlling unit 36 that adjusts ejection timing of each of the printing heads. The ejection frequency controlling unit 35 corrects the ejection frequency of all the printing heads based upon the print position deviation amount due to the conveyance error received from the deviation amount calculating unit 33 and a cyclic fluctuation of the conveying velocity in advance measured at the factory default or the like. The ejection timing controlling unit 36 corrects the ejection timing of each of the printing heads based upon the print position deviation amount of each of the printing heads received from the deviation amount calculating unit 33.

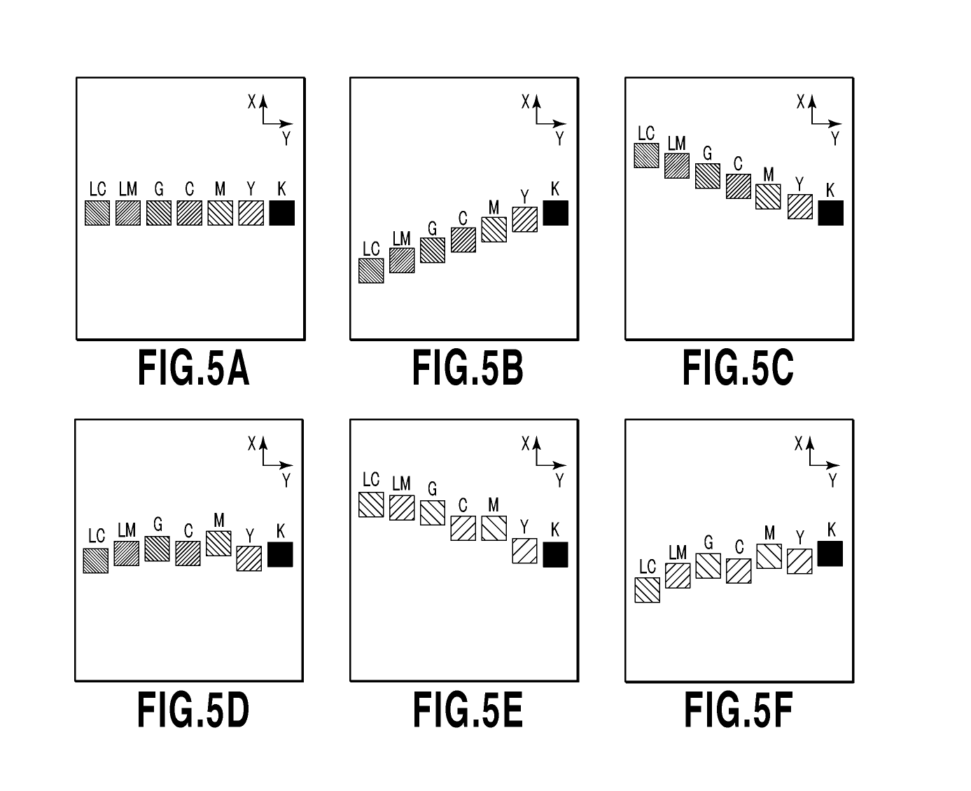

FIGS. 5A to 5F are diagrams each showing a printing state of a test pattern printed by the pattern formation controlling unit 31. FIG. 5A shows a test pattern that is printed on the sheet in a case where neither a print position deviation due to a conveyance error nor a print position deviation of an individual printing head exists. The test pattern is constructed of seven patches that are arranged in line in the Y direction. The seven patches are arranged in the order of black, yellow, magenta, cyan, gray, light magenta, and light cyan from the right. In a case of printing such a test pattern, by referring to FIG. 2, at first the rightmost black patch is printed by a printing head 14a of black positioned in the most upstream side in the conveying direction. Then in timing when the sheet is conveyed by a distance corresponding from the printing head 14a to a printing head 14b, the second yellow patch from the right is printed by the printing head 14b. In this way, in timing when the sheet is conveyed by a distance corresponding from the printing head 14a to each of the printing heads, each of the printing heads prints the corresponding patch, thus obtaining the test pattern as shown in FIG. 5A.

FIG. 5B shows a printing state where the conveying velocity of the sheet is faster than a reference velocity. When the sheet is conveyed faster than the reference velocity, for example, the printing head 14b of yellow prints the patch in timing delayed after a position where the printing head 14a has printed the patch comes. As a result, the yellow patch is printed to deviate from the black patch in the upstream side of the conveying direction. The same can be applied respectively to the other printing heads. The more downstream printing head is printed in the more upstream position in the more delayed timing from the black patch.

FIG. 5C shows a printing state where the conveying velocity of the sheet is slower than the reference velocity. When the sheet is conveyed slower than the reference velocity, for example, the printing head 14b of yellow prints the patch in timing earlier before a position where the printing head 14a has printed the patch comes. As a result, the yellow patch is printed to deviate from the black patch in the downstream side of the conveying direction. The same can be applied respectively to the other printing heads. The more downstream printing head is printed in the more downstream position in the earlier timing from the black patch.

Here, a deviation amount E_color in any printing head in the situation of FIG. 5B or FIG. 5C can be represented according to the following formula (1).

E_color=((V_ideal−V)/V_ideal)×D_color Formula (1)

In the above formula, V_ideal indicates a reference value of a conveying velocity of a sheet, V indicates an actual conveying velocity at the time a test pattern is printed, and D_color indicates a distance from the printing head 14a of black to any printing head.

On the other hand, FIG. 5D shows a printing state of a test pattern in a case where the conveying velocity of the sheet is equal to the reference value but the print position deviation is included in each of the printing heads. When the conveying velocity of the sheet is equal to the reference value, each of the printing heads can perform a printing operation on the sheet in a right position. However, when a print position deviation due to such as a mounting error is included in the printing head itself, the print positions by the respective printing heads are disposed discretely from each other as shown in FIG. 5D. At this time, when a deviation amount to a design value of an installment position of any printing head from an installment position of the printing head 14a of black is indicated at M_color, a print position deviation amount E_color of any printing head can be represented according to the formula (2).

E_color=M_color Formula (2)

FIG. 5E shows a printing state of a test pattern in a case where the conveying velocity of the sheet is slower than the reference value and the print position deviation is included also in each of the printing heads. In this case, a deviation amount E_color of any printing head can be represented according to a combined amount of the above formulas (1) and (2).

E_color=((V_ideal−V)/V_ideal)×D_color+M_color Formula (3)

FIG. 5F shows a printing state of a test pattern obtained when the pattern formation controlling unit 31 increases the conveying velocity to 1.05 times in a case where the pattern obtained by fixing the conveying velocity to a predetermined velocity is as shown in FIG. 5E. The print position deviation amount due to the conveyance error is reduced corresponding to the extent that the conveying velocity is faster by 5%. At this time, a deviation amount F_color of any printing head can be represented according to the following formula (4) simply by substituting the velocity V in the above formula (3) by 1.05V.

F_color=((V_ideal−1.05V)/V_ideal)×D_color+M_color Formula (4)

Further, an actual conveying velocity V of a sheet and an actual print position deviation amount M_color in an individual printing head can be represented as follows according to a simultaneous equation of the formulas (3) and (4).

V=((E_color−F_color)×V_ideal)/0.05·D_color Formula (5)

M_color=E_color−((V_ideal−V)/V_ideal)×D_color Formula (6)

Each of E_color and F_color is a value that is obtained by the pattern reading result obtaining unit 32, and each of V_ideal and D_color is a predetermined design value. Therefore the deviation amount calculating unit 33 uses the above formulas (5) and (6), thereby making it possible to calculate the actual conveying velocity V and the actual print position deviation amount M_color in the individual printing head.

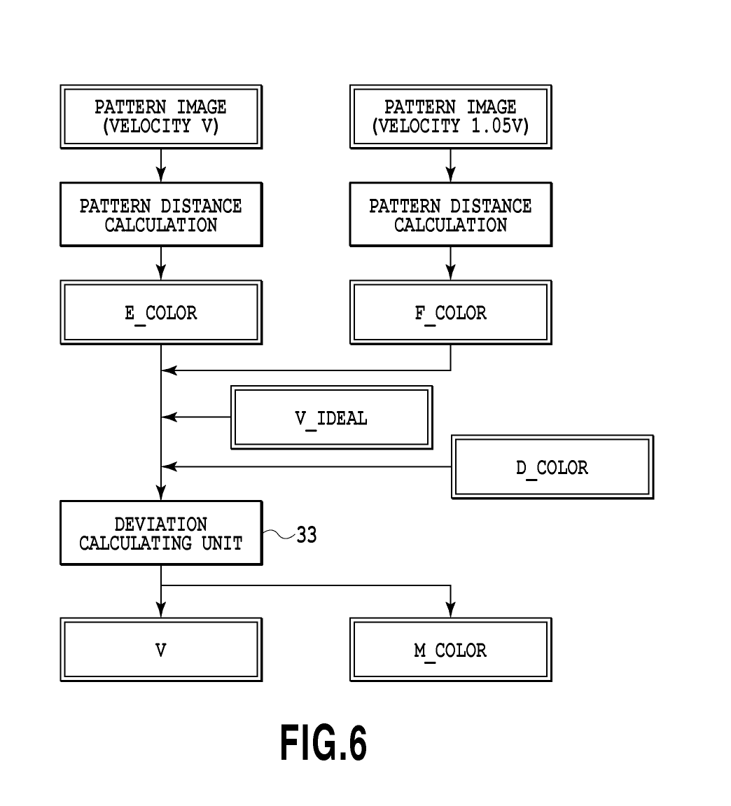

FIG. 6 is a concept diagram showing the process of obtaining the above various parameters, and the process of calculating a conveying velocity V of a sheet and a print position deviation amount M_color of an individual printing head, based upon these parameters. The test pattern is printed in a velocity V to be detected, thereby obtaining a deviation amount E_color of the individual printing head. Likewise, the test pattern is printed in a velocity 1.05V to be detected, thereby obtaining a deviation amount F_color of the individual printing head. Each of color patchs is composed of an identical bit pattern, and the deviation amount E_color (F_color) of each of the printing heads can be measured by performing pattern matching of detection data.

On the other hand, a reference value V of the conveying velocity in advance defined as a design value and a distance D from the printing head 14a of black are stored in the memory in the controlling unit 13, which can be read out by the deviation amount calculating unit 33. The deviation amount calculating unit 33 uses the above formulas (5) and (6) to calculate an actual conveying velocity V of a sheet and an actual print position deviation amount M_color in an individual printing head from the values of E_color, F_color, V_ideal and D_color.

According to the present embodiment in this way, the test patterns printed while conveying the sheet in a two-step velocity are measured, and the actual conveying velocity and the print position deviation specific in the printing head respectively can be obtained based upon two kinds of the print position deviations obtained from measuring the test patterns. In addition, a deviation amount of the print position due to the conveyance error can be calculated from the obtained actual conveying velocity V. As a result, a normal correction is made to each of the conveyance error and the print position deviation specific in the printing head, enabling a high-quality image without the print position deviation to be printed.

It should be noted that in the above-mentioned explanation, the second conveying velocity is set to 1.05 times as fast as the first conveying velocity as the reference value, but is not limited thereto. The conveying velocity may be set by any magnification ratio as long as the two-step conveying velocity is clearly in a state of being capable of being adjusted.

### Second Embodiment

Next an explanation will be made of the second embodiment where the printing and detecting of a test pattern are performed only in regard to a one-step conveying velocity, and a conveying velocity V and a print position deviation specific in a printing head are calculated without using a simultaneous equation.

FIG. 5 will be again referred to. In a case where only a conveyance error of a sheet is present, patches are respectively arrayed on a straight line having a given inclination as shown in FIG. 5B and FIG. 5C. On the other hand, in a case where a print position deviation in each of printing heads as well as the conveyance error of the sheet occur, the array of the respective patches is, as shown in FIG. 5E, not made on the same straight line. However, when the number of the patches increases to some degree, an inclination of the array can be calculated by finding an approximate formula. By focusing attention on this respect, V and M_color in the formula (3) are calculated from the print position deviation amount E_color measured in regard to the individual printing head and the distance D_color to the printing head 14a of black as a known value. Also in this method, each of the conveyance error of the sheet and the print position deviation specific in the printing head can be obtained as an approximate value to make a normal correction to each of them.

### Other Embodiments

In the first embodiment, “a cyclic fluctuation of the conveying velocity” are explained in the configuration of being in advance measured at the factory default for storage. However, “the cyclic fluctuation of the conveying velocity” can also be calculated by printing and detecting the pattern with the printing apparatus.

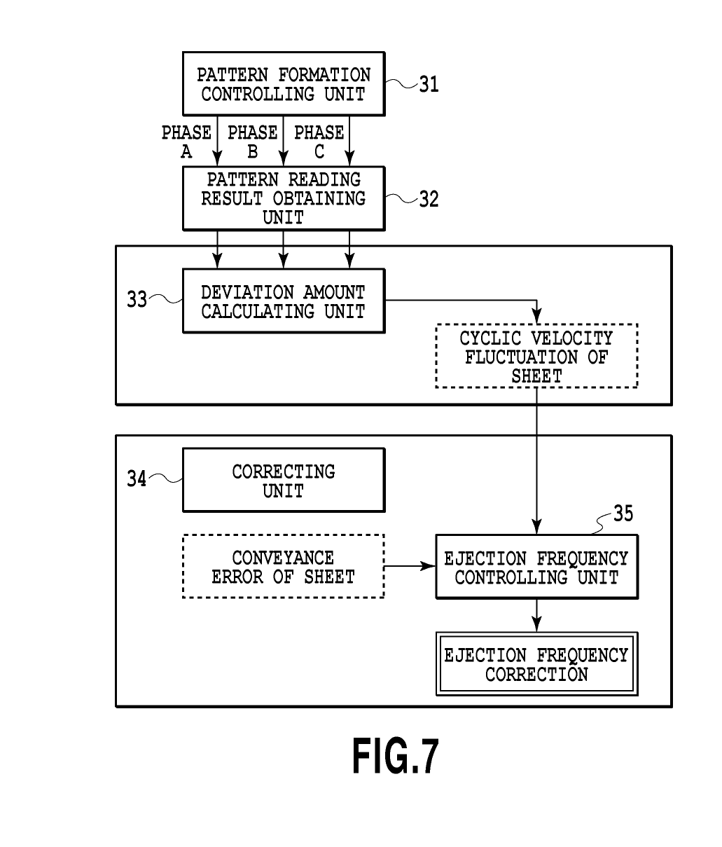

FIG. 7 is a block diagram for explaining the configuration that the controlling unit 13 detects “a cyclic conveying velocity fluctuation” and corrects a print position deviation based thereupon. It should be noted that in a case of detecting the cyclic conveying velocity fluctuation, it is supposed that the conveyance error of the sheet and the print position deviation specific in the printing head that are already explained in the first embodiment are subjected to the normal correction.

The printing of a test pattern is performed by the pattern formation controlling unit 31. At this time, the pattern formation controlling unit 31 prints three test patterns as similar to the above-mentioned pattern in a state where the phase of the main conveying roller 16 is made different in each of three steps. The pattern reading result obtaining unit 32 detects the three patterns with the inspection unit 5, and transmits each result to the deviation amount calculating unit 33.

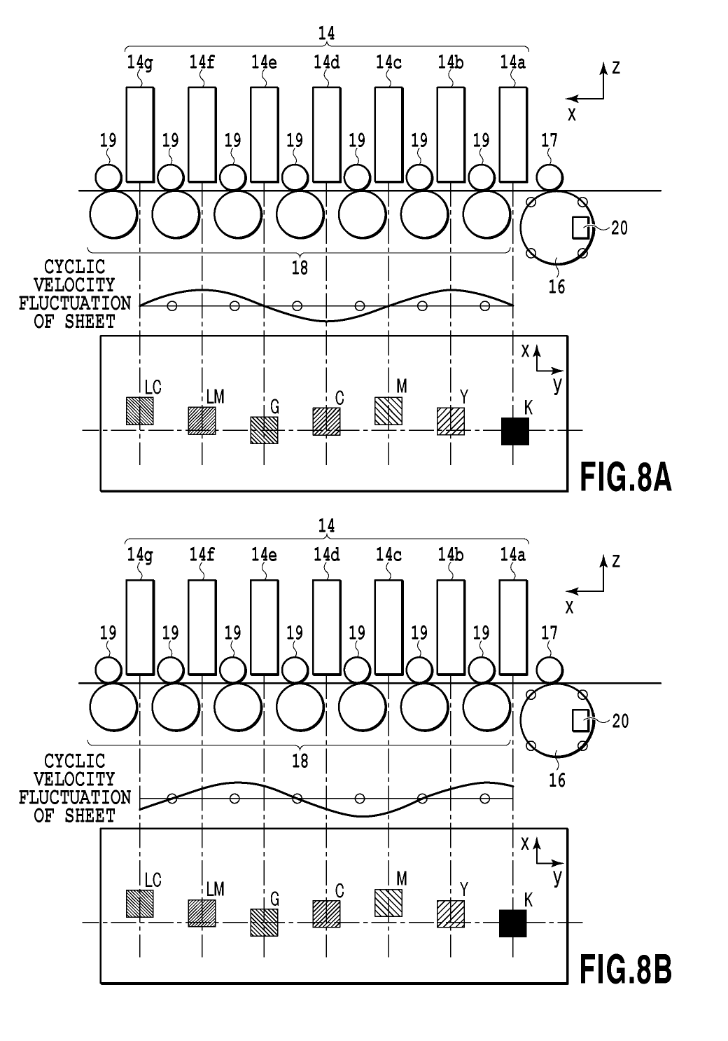

FIGS. 8A and 8B are diagrams showing printing states of two test patterns different in phase that are printed by the pattern formation controlling unit 31. The phase of the main conveying roller 16 is controlled by the encoder unit 20 attached on the main conveying roller 16. Since the print position deviation due to the conveyance error of the sheet and the print position deviation specific in the printing head are in advance subjected to the normal correction, it can be said that the position deviation between patches expressed in the figure is “the cyclic conveying velocity fluctuation” caused by eccentricity of the conveying roller or the like.

FIG. 7 will be referred back to. The pattern reading result obtaining unit 32 detects the three patterns printed in different phases with the inspection unit 5, and transmits each result to the deviation amount calculating unit 33.

The deviation amount calculating unit 33 executes pattern matching processing to the three detection results, and thereby obtains a cycle and an amplitude (deviation amount) in the cyclic conveying velocity fluctuation to be stored in the memory. The ejection frequency controlling unit 35 in the correcting unit 34 corrects an ejection frequency of all the printing heads based upon the conveying velocity explained in the first embodiment and the updated “cyclic conveying velocity fluctuation” obtained this time. Therefore the print position deviation due to the conveyance error of the sheet and the print position deviation specific in the printing head, as well as the print position deviation due to “the cyclic conveying velocity fluctuation” can be corrected at the same time.

Incidentally hereinbefore, the configuration that the test pattern printed in the printing unit 4 is detected by a line sensor disposed in the inspection unit 5 is explained, but the detection of the test pattern and determination of the result can be committed to users.

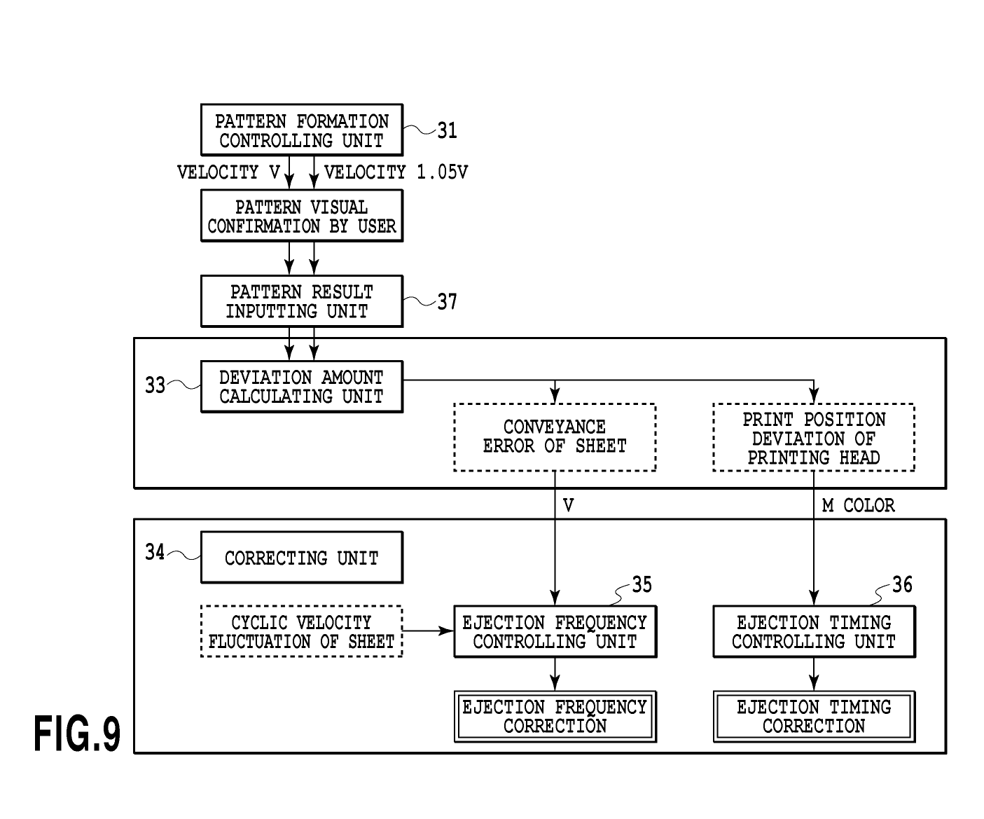

FIG. 9 is a block diagram explaining the configuration of control in detection and correction of a print position deviation that is executed by the controlling unit 13 and users. The pattern formation controlling unit 31 prints an equal test pattern in each of a state of fixing the conveying velocity in the predetermined velocity V and a state of fixing the conveying velocity to 1.05 times of V (1.05V). After that, the user visually confirms the two output test patterns, and inputs given information through a pattern result inputting unit 37.

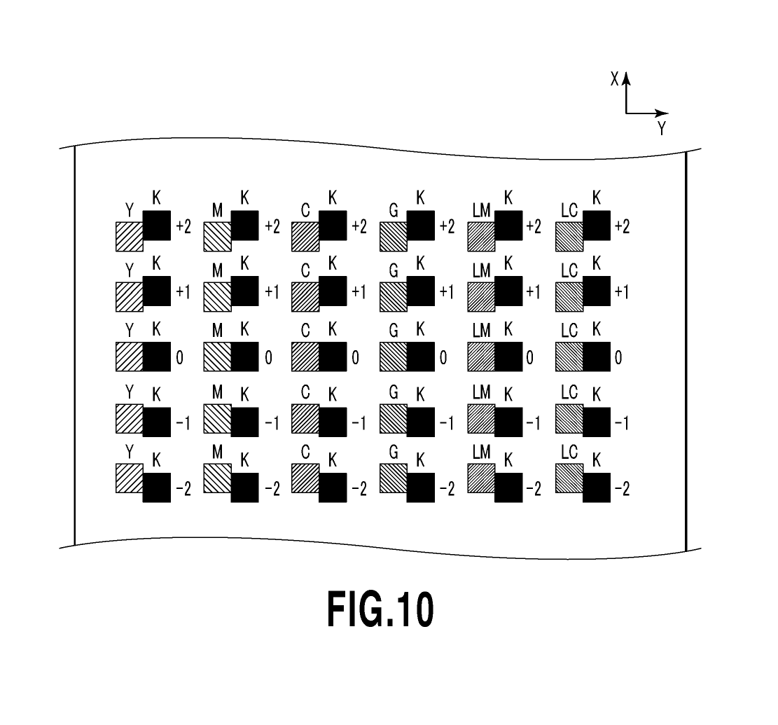

FIG. 10 is a diagram showing examples of test patterns for visual determination by users. A black patch as reference is printed to be neighbored to a lateral side of each of color patches other than black, so that the degree and direction of a deviation in the X direction can be visually confirmed. Further, a plurality of patches of which such a degree of the deviation is made different in a plurality of steps are printed. The user selects a color patch whose deviation amount from a black patch is the fewest among the plurality of patches, and inputs the patch number of each of ink colors. At this time, the user may input the information through the pattern result inputting unit 37 equipped in the printing apparatus, but may input the information through the host apparatus 16 connected to an external device. Thereafter, the deviation amount calculating unit 33 calculates an error amount of the conveying velocity and a print position deviation amount of the individual printing head based upon the information received from the user according to the above-mentioned predetermined formula.

It should be noted that in the above-mentioned embodiments, the printing unit 4, the inspection unit 5, the cutter unit 6 and the drying unit 8 are arranged in that order in FIG. 1, but the present invention is not limited to such an arrangement order. Depending upon the kind of a sheet, there are some cases where when ink is applied on the sheet in the printing processing, the fiber of the sheet is expanded/contracted and therefore measurement of the print position deviation cannot be accurately performed in the inspection unit 5 immediately after that. In such a case, it is preferable to execute the reading-out processing by the inspection unit 5 to the sheet having been subjected to the drying processing by the drying unit 8.

The present invention is not limited to the embodiments that are above-mentioned and shown in the figures, and can be executed by modifying the embodiments as needed within the scope not changing the subject matter. For example, a method of being connected to an external scanner may be adopted as means of reading out the test pattern. In addition, the printing may be performed, not on the continuous sheet but on a fixed cut sheet, and a double-sided printing function may be not provided.

Further, the present invention can be achieved in the processing in which the program of realizing one or more functions in the above-mentioned embodiments is supplied to a system or an apparatus through a network or a storage medium and one or more processors in a computer in the system or apparatus read out the program for execution. In addition, the present invention can be also achieved with a circuit (for example, ASIC) that realizes one or more functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-060482, filed Mar. 24, 2014, which is hereby incorporated by reference wherein in its entirety.

What is claimed is:

1. A printing apparatus comprising:
a plurality of line-type printing heads,
a print control unit configured to control such that a test pattern constructed of a plurality of patches is printed on a conveyed sheet by using the plurality of printing heads;
an obtaining unit configured to obtain a deviation amount of each of the plurality of patches based upon the result of detecting the test pattern; and
a calculating unit configured to calculate a print position deviation due to a conveyance error of the sheet and a print position deviation specific in each of the plurality of printing heads, based upon the deviation amount of each of the plurality of patches.

2. The printing apparatus according to claim 1 wherein
the print control unit controls such that a first test pattern is printed while conveying the sheet in a first conveying velocity and a second test pattern is printed while conveying the sheet in a second conveying velocity different from the first conveying velocity,
the obtaining unit obtains the deviation amount of each of the plurality of patches corresponding to the first conveying velocity based upon the result of detecting the first test pattern and obtains the deviation amount of each of the plurality of patches corresponding to the second conveying velocity based upon the result of detecting the second test pattern, and
the calculating unit calculates the print position deviation due to the conveyance error of the sheet and the print position deviation specific in each of the plurality of printing heads from the deviation amount of each of the plurality of patches corresponding to the first conveying velocity and the deviation amount of each of the plurality of patches corresponding to the second conveying velocity through a simultaneous equation.

3. The printing apparatus according to claim 1 wherein the calculating unit calculates the print position deviation due to the conveyance error of the sheet and the print position deviation specific in each of the plurality of printing heads by finding an approximate equation based upon the deviation amount of each of the plurality of patches.

4. The printing apparatus according to claim 1 wherein the obtaining unit obtains the deviation amount of each of the plurality of patches based upon the result of detecting the test pattern by an image sensor.

5. The printing apparatus according to claim 1 wherein the obtaining unit obtains the deviation amount of each of the plurality of patches based upon the result of detecting the test pattern and inputting by a user.

6. The printing apparatus according to claim 1, further comprising:
a correcting unit configured to correct a print position of each of the plurality of printing heads on the sheet by adjusting an ejection frequency of the plurality of printing heads based upon the print position deviation due to the conveyance error of the sheet calculated by the calculating unit and by adjusting ejection timing of each of the plurality of printing heads based upon the print position deviation specific in each of the plurality of printing heads.

7. The printing apparatus according to claim 6 wherein the correcting unit adjusts the ejection frequency of the plurality of printing heads, based upon the print position deviation due to the conveyance error of the sheet calculated by the calculating unit and information in regard to a cyclic conveying velocity fluctuation of the sheet in advance stored.

8. The printing apparatus according to claim 6 wherein
the calculating unit further calculates a print position deviation amount due to a cyclic conveying velocity fluctuation of the sheet based upon the deviation amount of each of the plurality of patches, and
the correcting unit adjusts the ejection frequency of the plurality of printing heads, based upon the print position deviation due to the conveyance error of the sheet and the print position deviation due to the cyclic conveying velocity fluctuation of the sheet, calculated by the calculating unit.

9. The printing apparatus according to claim 1, further comprising:
a drying unit configured to dry the test pattern, wherein
the obtaining unit obtains the deviation amount of each of the plurality of patches based upon the result of detecting the test pattern having been dried by the drying unit.

10. A printing method comprising the steps of:
printing a test pattern constructed of a plurality of patches on a conveyed sheet by using a plurality of line-type printing heads;
obtaining a deviation amount of each of the plurality of patches based upon the result of detecting the test pattern;
calculating a print position deviation due to a conveyance error of the sheet and a print position deviation specific in each of the plurality of printing heads, based upon the deviation amount of each of the plurality of patches;
adjusting an ejection frequency of the plurality of printing heads based upon the calculated print position deviation due to the conveyance error of the sheet; and
adjusting ejection timing of each of the plurality of printing heads based upon the print position deviation specific in each of the plurality of printing heads.
